(19) United States
(12) Patent Application Publication
(10) Pub. No.: US 2017/0308765 A1
(43) Pub. Date: Oct. 26, 2017

(54) PANORAMIC 360 DEGREE CAMERA SYSTEM FOR LAW ENFORCEMENT

(71) Applicant: Larry Molina, Fulton, TX (US)

(72) Inventor: Larry Molina, Fulton, TX (US)

(21) Appl. No.: 15/645,014

(22) Filed: Jul. 10, 2017

Related U.S. Application Data
(63) Continuation-in-part of application No. 15/054,443, filed on Feb. 26, 2016.

(51) Int. Cl. G06K 9/20; H04N 7/18; B60R 11/04; G06K 9/32; G06T 3/00; G07C 5/08

(52) U.S. Cl. CPC G06K 9/2081; G06K 9/3233; G06T 3/0062; H04N 7/181; B60R 11/04; G06T 2207/30; G06T 2207/30252; G07C 5/0866; G06T 2207/30248

(57) ABSTRACT

A system for law enforcement recording that includes: a robotic camera; a position transmitter on the robotic camera; and at least one receiver, where the at least one receiver is adapted to be worn by a user. The robotic camera captures panoramic views surrounding the at least one receiver. The receiver may be worn by the user in the form of an armband or strip placed on a user's hat.

### CROSS REFERENCE TO OTHER APPLICATIONS

This application is a continuation in part to U.S. patent application Ser. No. 15/054,443 filed on Feb. 26, 2016.

### BACKGROUND OF THE INVENTION

### Field of Invention

The present invention relates to a system to record the activities of law enforcement personnel.

### Description of Related Art

Scrutiny of law enforcement activities have increased and further expansion of video recording has been suggested. Many police departments are utilizing body cams in order to record police activity during active duty. The down side to the use of body cams is that the camera is not always turned on, and because it is attached to the garment of the officer the footage is not always clear as to what is happening. This would work great if the body cam was stable and not moving up and down with the garment that it is attached to. Further dash cams are also used to record police activity on a traffic stop and other arrests that may occur. One drawback to the use of dash cams is that the dash camera is restricted in its range of view. This view of the dash cam is fixed forward position, with a view that is fixated over the front of the vehicle. The drawback of the dash cam is its limited range. On occasion police activity goes outside the line of sight of the dash cam and therefore the amount of evidence and proof available is limited or diminished. One reason for this use of dash cams to constantly record footage of a vehicle on the road. This reason is about minimizing the risk of a “Your word against mine” situation. Camera footage is becoming increasingly accepted for insurance claims and proving liability. Dash Cam footage can absolve you of blame in situations where you would otherwise be at fault. For example, where a case might go to court without footage, the existence of clear footage that apportions blame can create a change of heart that leads to an out-of-court settlement. As a result, it would be advantageous to have a system that could actively follow the police officer during a traffic stop or while engaging other arrests or police activity regardless of where the officer may be proximity to the robotic camera. The camera will record every movement of the officer whether it be in the front, back or on either side of the vehicle, he/she is being recorded. And the camera is recording from a stable stationary point. No sudden movements that are too close to the officer to determine what is going on. The robotic camera will provide a clear view of all actions of both parties the officer and the citizen. This evidence would be vital in a court. The justification of justice. No question.

### SUMMARY OF THE INVENTION

The present invention relates to a system for law enforcement recording that includes: a robotic camera; and receiver. The robotic camera captures a panoramic view surrounding the receiver. The receivers may be worn by the user in a form of a armband or a strip placed on the users hat.

### BRIEF DESCRIPTION OF DRAWINGS

FIG. 1 depicts a robotic camera on a patrol vehicle in accordance with the present invention.

FIG. 2 depicts the robotic camera in a more detailed view in accordance with the present invention.

FIG. 3 depicts an armband with receivers used in conjunction with the robotic camera.

FIG. 4 depicts a hat with a receiver band used in conjunction with the robotic camera.

### DETAILED DESCRIPTION

The present invention relates to a system that implements a robotic dash cam that is engaged with a receiver worn by a police officer. The robotic camera is fixated on top of the police emergency light bar or on top of the vehicle, if no emergency light bar is present, overlooking the front of the vehicle, once the officer driving the police vehicle opens the driver side door. The camera will spin 270 degrees or spin left (counter clockwise) 90 degrees and synced with the receiver worn by the officer. The robotic camera detects the receiver and follows and records the movement of the officer 360 degrees all the way around the unit.

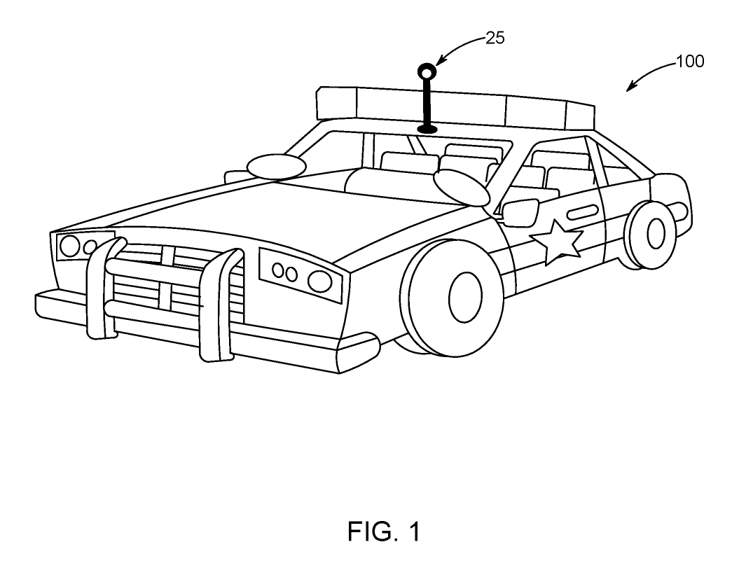

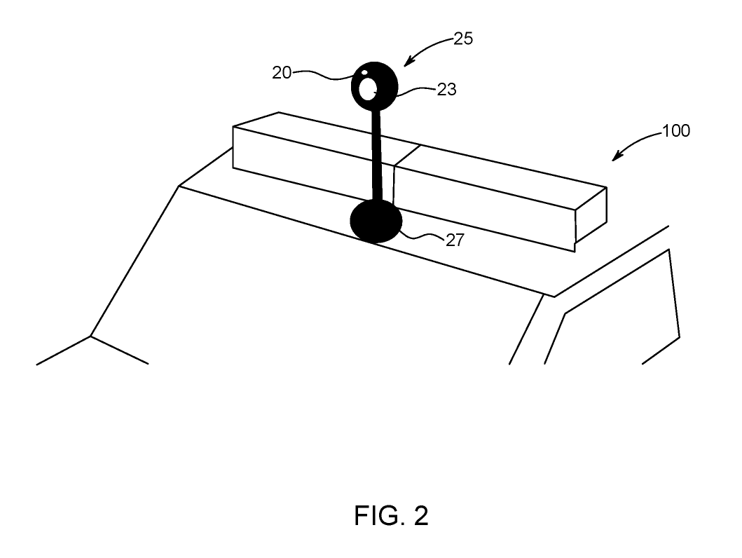

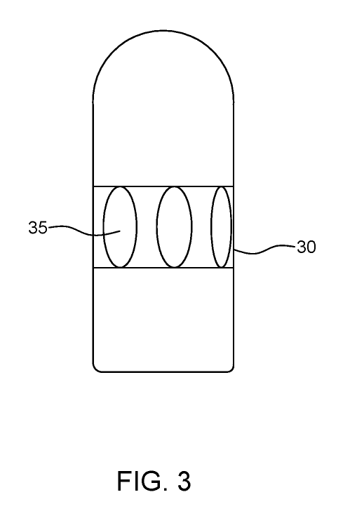

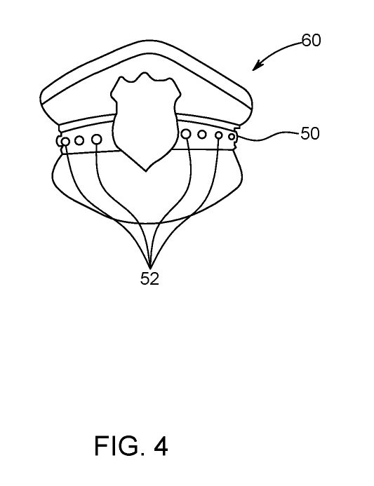

In reference to FIG. 1, a robotic camera 25 is shown fixed on top of a police patrol car 100. Camera 25 provides a means to record any activity related to a police officer who wears a receiver in the form of a armband 30 as shown in FIG. 3 or a band on their cap 60 as shown in FIG. 4. FIG. 2 depicts the camera 25 in a more detailed view. In this detailed view, camera 25 includes lens 23 and a sensor 20. The sensor 20 allows the camera 23 to track the activity of the police officer wearing either armband receiver 30 or cap band 50 as shown in FIG. 4. The armband 30 includes receivers 35 and the cap band 50 includes receivers 52. The receivers 35, 52 communicate with the sensor 20 and enables the 360-degree tracking of officer's activities surrounding the patrol vehicle 100. The camera 25 is mounted on top of the patrol vehicle 100 as shown with a mounting base 27. The system enables the robotic camera 25 to track police officer activity surrounding any patrol vehicle 100 with the camera 25 installed.

The robotic camera 25 with its panoramic view has the ability to rotate 360-degrees and pitch downward around the perimeter of the car. Capable of following the receivers 35, 52 around the vehicle 100. Preferably, the camera 25 is mounted on the emergency light bar or is magnetically mounted to the top of the vehicle. The camera 25 films activities over the front of the vehicle 100 (at its home position). When the driver side door is opened, the robotic camera 25 will spin 270 degrees in a clockwise motion or 90-degrees and sync-up with receivers 35 worn on the armband 30 or receivers 52 on the hatband 50 of the officer and will follow the officer. A transmitter enables an automatic adjustment of the focus and range of the camera and allows the camera to follow movement associated with the receiver. This system provides a complete visual recording of activates associated with the police officer by providing panoramic views captured by the robotic camera 25. Thus, an automatic robotic camera system is provided along a greater collection of visual evidence regarding police officer activity. The instant invention has been shown and described in what it considers to be the most practical and preferred embodiments. It is recognized, however, that departures may be made there from within the scope of the invention and that obvious modifications will occur to a person skilled in the art.

What is claimed is:

1. A system for law enforcement recording comprising:
a. a robotic dash camera;
b. a position transmitter on the robotic dash camera; and
c. at least one receiver, where the at least one receiver is adapted to be worn by a user;

2. The system for law enforcement recording system according to claim 1, where one receiver is placed on a strip, wherein strip is adapted for placement on a hat.

3. The system for law enforcement recording system according to claim 1, where the robotic dash camera captures panoramic views surrounding the at least one receiver.

4. The system for law enforcement recording system according to claim 1, where the user is a law enforcement officer.

5. The system for law enforcement recording system according to claim 1, where one receiver is placed on an armband worn by the user.
